(19) United States
(12) Patent Application Publication
(10) Pub. No.: US 2021/0248846 A1
(43) Pub. Date: Aug. 12, 2021

(54) Method and System for Detecting Data in Vehicles

(71) Applicant: Bayerische Motoren Werke Aktiengesellschaft, Muenchen (DE)

(72) Inventor: David MATZEK, Muenchen (DE)

(21) Appl. No.: 17/054,888

(22) PCT Filed: Jul. 5, 2019
(86) PCT No.: PCT/EP2019/068059

§ 371 Date: Nov. 12, 2020

(30) Foreign Application Priority Data
Jul. 9, 2018 (DE) 10 2018 211 257.6

(51) Int. Cl. G07C 5/08

(52) U.S. Cl. CPC G07C 5/0825

(57) ABSTRACT

Usage data in a vehicle is detected by a vehicle system. The vehicle includes a user interface and a communication unit. Configuration data is received via the communication unit, which is designed for the user interface. The configuration data configures the user interface based on the configuration data. Usage data is detected based on usage of the user interface by the user of the vehicle.

### BACKGROUND AND SUMMARY OF THE INVENTION

The disclosure concerns methods and systems for detecting data in vehicles. The disclosure concerns methods and systems for detecting data in vehicles where the data detection relates to the operating of vehicle user interfaces. The data detection allows an evaluation and assessment of vehicle user interfaces and the interaction of a user with them.

User interfaces are assessed in the course of studies in order to evaluate certain properties of user interfaces in the sense of the user experience and to ascertain their suitability (for example, user understanding, function, ease of operation, traceability, effectiveness, exclusion or minimization of operating errors). Such studies are conducted with the aid of corresponding mock-ups (for example, so-called seat boxes), virtual reality or simulators, which provide a user with a new or modified user interface in an environment that comes as close as possible to the later application in order to draw a conclusion as to the quality of the user interface on the basis of the interaction of the user or the implicit and explicit response of the user.

There is potential to optimize the aforementioned studies in several respects. On one hand, only a small number of test subjects can be achieved, since the means necessary for implementation are only available in a limited number and in particular their construction and operation is comparatively expensive. In addition, it is often not possible to replicate the context of genuine applications completely and convincingly (for example, fatigue of a vehicle user occurring during longer journeys; occurrence, change or variations of climatic conditions; interdependencies between the driver activities of the user and secondary operating activities). Therefore, resultant test and assessment results cannot precisely reflect reality and an interpretation within the context of the simulation is necessary. Moreover, context-dependent functions, for example, learning functions, which are acquired over a longer period of time under actual conditions, cannot be adequately and/or reliably assessed.

Studies that have been conducted by customers based on or in production vehicles are also known for the aforementioned purpose. Such studies on a production vehicle are very time-consuming and cost-intensive, since vehicles are modified or reprogrammed and provided with measuring equipment for the tests or assessment. In addition, suitable test subjects must be acquired. This often results in only very small, and not very representative, test groups of users, which has the effect that the test and assessment results obtained are not very informative.

Methods and systems known in the prior art usually have one or more of the aforementioned disadvantages.

The document US 2011/0320089A1 describes a method of updating a vehicle ECU (Electronic Control Unit). The method includes establishing communication between a data communications module of a vehicle and an update server via a cellular network, validating the vehicle using a key exchange protocol between the data communications module and the update server, and sending update information from the update server to the data communications module of the vehicle via the cellular network, the update information being configured to be used to update the vehicle ECU. The described method is confined to the regular updating of software components in vehicles. No mention is made of detecting user behavior or drawing conclusions from it.

Embodiments of the presently disclosed methods and systems partly or completely overcome one or more of the aforementioned disadvantages and make possible one or more of the following advantages.

The present subject matter improves data detection concerning the interaction of users with user interfaces in vehicles. The disclosed methods and systems detect data more precisely, which replicates specific applications closely or identically to the practical reality.

The present subject matter also makes an application close or identical to reality of prototype user interface implementations for gathering user data based on a user group that is substantially of a predetermined composition. For example, users of certain age groups, a certain gender, users of certain vehicle types or vehicle classes, users with certain user profiles (for example, long distance, short distance, private users, professional users), users in certain regions (for example, country, town, Alpine regions), users from different countries and/or climatic zones, and so on and so forth, can be flexibly included in a group to be defined for a specific data detection. The composition can be parameterized substantially in any way desired.

The present subject matter describes a low-cost implementation of the data detection. This is based primarily on the configuration data transmitted by digital data transmission into the vehicle for the user interface taken as a basis for the data detection, which can be integrated or refitted into the vehicle without it spending a corresponding time undergoing a service.

It is an object of the present subject matter to detect data in vehicles that avoid one or more of the aforementioned disadvantages and realize one or more of the aforementioned advantages. It is an object of the present subject matter to provide methods and systems for detecting data in vehicles that concern the operating of vehicle user interfaces and make possible an evaluation and assessment of vehicle user interfaces and the interaction of a user with them. It is also an object of the present subject matter to provide vehicles comprising such systems that avoid one or more of the aforementioned disadvantages and realize one or more of the aforementioned advantages.

According to embodiments of the present subject matter, a method for detecting data in vehicles is provided. The vehicle comprises a user interface and a communication unit. The method comprises receiving configuration data, which are intended for the user interface, via the communication unit; configuring the user interface based on the configuration data; and detecting usage data based on a usage of the user interface by a user of the vehicle. Optionally, the method may also comprise sending the usage data via the communication unit.

Preferably, the method also comprises detecting response data based on a response of the user concerning the usage of the user interface by the user. Optionally, the method may also comprise sending the response data via the communication unit.

Preferably, the method also comprises receiving second configuration data, which are intended for the user interface, via the communication unit, the second configuration data differing from the configuration data; and configuring the user interface based on the second configuration data.

Preferably, the method also comprises storing current configuration data of the user interface as second configuration data, the storing of the second configuration data taking place before the receiving of the configuration data; and configuring the user interface based on the second configuration data.

Preferably, the method also comprises modifying the configuration data based on the usage data and/or of the response data, to obtain modified configuration data; and configuring the user interface based on the modified configuration data.

Preferably, the method also comprises transmitting a request for participation in a detection of usage data to the user, preferably to a mobile terminal of the user; and receiving a confirmation of the user's participation; optionally where the steps of transmitting the request and receiving the confirmation take place before the step of receiving the configuration data.

Preferably, the method also comprises detecting an assessment of the usage of the user interface by the user, the assessment optionally including one or more parameters that qualitatively and/or quantitatively characterize the usage of the user interface by the user.

According to embodiments of the present subject matter, a system for detecting usage data in a vehicle is provided. The system comprises an electronic control unit, the electronic control unit being configured for performing the method according to the embodiments described here. The system optionally also comprises the communication unit and the user interface.

Preferably, the system also comprises a backend component, which is configured for sending the configuration data to the vehicle via the communication unit, the backend component optionally also being configured for receiving the response data from the vehicle.

According to embodiments of the present subject matter, a vehicle comprising the system according to the embodiments described here is provided.

### BRIEF DESCRIPTION OF THE DRAWINGS

FIG. 1 shows a schematic representation of a system for detecting data in vehicles according to an embodiment of the present subject matter.

FIG. 2 shows a flow diagram of a method for detecting data in vehicles according to an embodiment of the present subject matter.

### DETAILED DESCRIPTION OF THE DRAWINGS

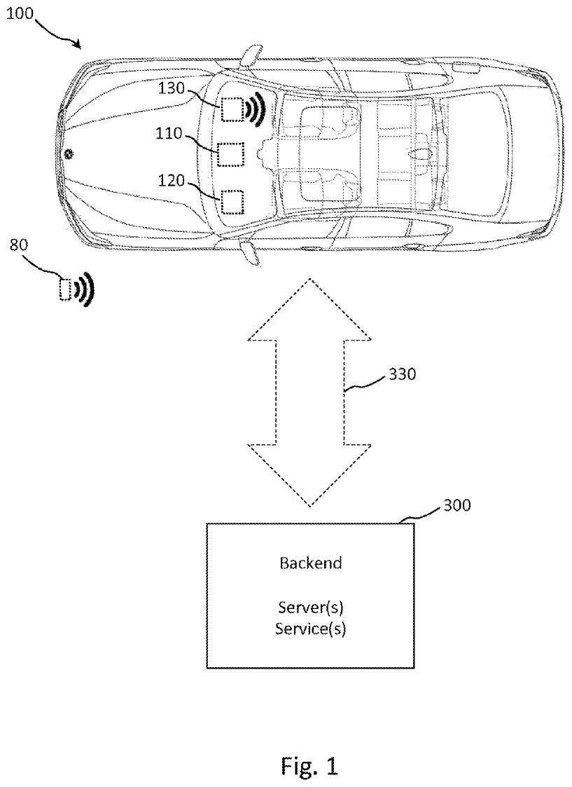

FIG. 1 shows a schematic representation of a system for detecting data in vehicles 100 according to embodiments of the present subject matter. The system may substantially be configured on an electronic control unit 120 of the vehicle 100. Apart from the electronic control unit 120, the vehicle 100 also comprises a communication unit 130, which is configured for data communication with components external from the vehicle (for example, mobile terminals 80 and a backend 300), and a user interface 110.

The user interface 110 includes one or more user interfaces that are configured for operating the vehicle 100 (for example, air conditioning, seat adjustment, infotainment, vehicle settings). The user interface 110 may be configured in its function by configuration data. For example, the user interface 110 may implement, based on corresponding configuration data, a graphic user interface (for example, a touchscreen) in which indicating elements and operating elements that can be used by the user for operating the vehicle 100 are represented. Additionally, or alternatively, the user interface may include (further) indicating and operating elements, for example, switches, knobs and displays.

The function of the user interface 110 is determined by the configuration data in such a way that predetermined operating elements, indicating elements and/or an operating logic and so on and so forth can be defined and activated or deactivated based on the configuration data. Thus, new functions, new operating elements and/or new indicating elements may be added to the user interface. Equally, functions, operating elements and/or indicating elements may be removed or modified. An evaluation or assessment of the user interface 110 that is implemented by the user based on new or modified configuration data thus allows an optimization of the user interface regarding understandability, function, functional scope, effectiveness, and so on and so forth.

The system may also have a backend component 300 or infrastructure external from the vehicle 100, which provides one or more resources (for example, servers, services). Preferably, configuration data is produced, managed, or provided on the backend component 300 and transferred as and when required to one or more vehicles 100 by means of data transmission 330. Equally, the data gathered in one or more vehicles 100 may be transferred by means of data transmission 330 to the backend component 300 for storage, evaluation, and/or further processing.

A user (not shown in FIG. 1) preferably communicates via a mobile terminal 80 with the system (for example, with the vehicle 100 and/or the backend component 300). Thus, the user may, for example, be asked by means of a suitable application program (for example, app on a smartphone) to participate in the data detection for a new/modified user interface. Based on data stored in the app (for example, profile data of the user and/or of the vehicle), a selection of suitable users from a set of users may be made. For example, users may be selected on the basis of a wide variety of criteria: users of certain age groups, a certain gender, users of certain vehicle types or vehicle classes, users with certain user profiles (for example, long distance, short distance, private users, professional users), users in certain regions (for example, country, town, Alpine regions), users from different countries and/or climatic zones and so on and so forth.

When confirmed by the user, configuration data that implement a new or modified user interface 110, can be transferred to the vehicle 100 via the air interface (for example, “over the air”, OTA) or in some other way. Preferably, the electronic control unit 120 in the vehicle 100 receives the configuration data and installs it in accordance with a predetermined scheme. In this case, optionally, configuration data that is present in the vehicle 100 and implements a user interface 110 used until then may be saved before the installation of the received configuration data for restoring the original state of the user interface 110 after completion of the data detection. Alternatively, after completion of the data detection, corresponding configuration data may in the same way be transferred to the vehicle 100 and installed, as described above.

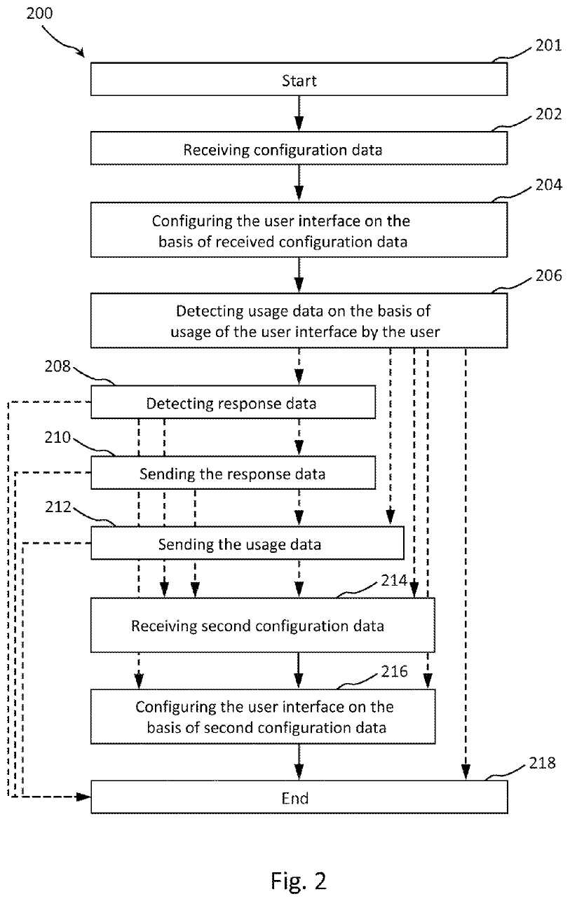

FIG. 2 shows a flow diagram of a method 200 for detecting data in vehicles 100 according to embodiments of the present subject matter. The transitions represented by dashed lines (for example, from step 206 to step 208) represent optional transitions. As shown, after step 206, it is optionally possible to continue with step 208, 212, 214, 216 or 218. Transitions depicted by solid lines (for example, from step 202 to step 204) represent transitions for which there are usually no alternatives.

The method 200 starts at step 201. In step 202, configuration data, which is intended for the user interface 110, is received via the communication unit 130 of the vehicle 100. As described above, the reception preferably takes place via an air interface and is controlled by way of the electronic control unit 120 of the vehicle 100. Alternatively, the configuration data may also be received “locally”, for example, via a data carrier that is present in the vehicle or can be connected (not shown).

In step 204, the user interface 110 is configured based on the configuration data. This may include the installation of a new software component on a corresponding control device of the user interface, for example, by the electronic control unit 120 of the vehicle 100. Here, the user interface 110 implements based on the configuration data a new or modified user interface 110, concerning which a data detection (i.e. evaluation, assessment) is intended to take place.

In step 206, usage data is detected based on a usage of the user interface 110 by a user of the vehicle 100. This detection preferably takes place over a predetermined time period (for example, one or more days, weeks or months). Alternatively, usage data, for example, with the agreement of the user to corresponding data protection regulations, may also be acquired permanently. For example, in the case of use of the air conditioning in the vehicle, the entire context may be permanently acquired for a greater number of users, to obtain correspondingly informative and robust data. With an increase in the data acquired and based on a sufficiently great number of users, the results of the data acquisition can be significantly improved.

Data may in this case be acquired implicitly and/or explicitly. Implicitly acquired data may for example, concern a regular interaction of the user with the user interface 110 and a multiplicity of parameters. This concerns for example, the type and number of interactions. If a user uses certain operating elements very often and for a sustained time to set the same or similar parameters (for example, sustained readjustment of the air conditioning or switching on/off the seat heating), this may indicate a less than optimum design of the operating, indicating, and/or controlling of the air conditioning. Furthermore, for example, response or reaction times of the user to events may be detected. If the reactions take place quickly and precisely, a clearly laid out, easily operable and efficient user interface can then usually be assumed. Furthermore, the number of settings of individual or various parameters by the user may be detected, for example, to establish how quickly and by means of what number of operating steps a user can initiate, operate, or set a desired function.

After step 206, it is optionally possible to continue with step 208, 212, 214 or 216. Alternatively, the method subsequently ends at step 218.

Optionally, the method is continued in step 208. In step 208, response data are detected based on a response of the user concerning the usage of the user interface 110 by the user.

After step 208, it is optionally possible to continue with step 210, 212, 214 or 216. Alternatively, the method subsequently ends at step 218.

Optionally, the method is continued in step 210. In step 210, the response data are sent via the communication unit 130. As described above with reference to step 202, the response data are preferably sent to a backend component 300 for further evaluation or processing. In some embodiments, however, a data transmission to other components may take place, for example, also locally to the controller (for example, for storage and/or later data transmission) or to a locally connected data carrier (for example, USB stick or the like). Response data may comprise data based on an active response of the user, for example, data from a customer survey with respect to the user interface or otherwise explicitly from the user, possibly data made available without being requested. The user has in this way the possibility of giving, beyond the purely technical detection of usage data, further responses (for example, free assessment, likes, suggestions for improvement) of a quantitative kind (for example, grades, time expended) and a qualitative kind and/or concerning subjective perception.

After step 210, it is optionally possible to continue with step 212, 214, or 216. Alternatively, the method subsequently ends at step 218.

Optionally, the method is continued in step 212. In step 212, the usage data is sent via the communication unit 130. As described above with reference to step 202, the usage data is preferably sent to a backend component 300 for further evaluation or processing. In some embodiments, however, a data transmission to other components may take place, for example, also locally to the controller (for example, for storage and/or later data transmission) or to a locally connected data carrier (for example, USB stick or the like).

After step 212, it is optionally possible to continue with step 214. Alternatively, the method subsequently ends at step 218.

Optionally, the method is continued in step 214. In step 214, second configuration data, which are intended for the user interface 110, are received via the communication unit 130. The second configuration data preferably differ from the configuration data to the extent that they restore an original state of the user interface 110, as it was before the configuring 204 based on the configuration data. Subsequently, in step 216, the user interface 110 is configured based on the second configuration data, to restore the original state.

In a further embodiment (not shown in FIG. 2), in a step 202-1, preceding step 202 and/or step 204, current configuration data of the user interface 110 are stored as second configuration data. The storing 202-1 of the second configuration data preferably takes place before the receiving 202 of the configuration data, to save an original state of the user interface 110, based on the second configuration data. Later, for example, in step 216, the user interface 110 can then be configured based on the second configuration data, to restore the original state.

In a further embodiment (not shown in FIG. 2), configuration data, for example, configuration data, may be modified based on the usage data and/or the response data 118, to obtain modified configuration data. Various methods may be used here. For example, the usage data and/or the response data may be processed based on KI methods (for example, machine learning) to the effect that one or more properties of the user interface 110 are changed by means of the modified configuration data based on the usage data and/or the response data. Such changes may for example, include that elements perceived to be positive (for example, indications, operating elements, automatic controls) are correspondingly extended and optimized, and/or that elements perceived to be negative are correspondingly removed, modified, or otherwise optimized. The usage data and/or the response data may include quantitative and/or qualitative items of information that allow conclusions concerning corresponding user preferences.

In this way, user interfaces 110 can be optimized increasingly in the direction of user preferences, optionally by way of several iterations (for example, stages of evolution), which are respectively based on (further) modified configuration data. In some embodiments, long-term trends (for example, changes of user preferences occurring in the longer term) can thus also be depicted in the permanently and/or continuously optimized user interfaces.

Preferably, the methods used for producing modified configuration data can be performed on one or more backend components 300. Thus, resource-intensive processes (which for example, presuppose large storage capacities and/or computing powers) can be outsourced to corresponding infrastructures.

When reference is made in the present case to a vehicle, this is preferably a multitrack motor vehicle (passenger car, truck, transporter). This gives rise to several advantages that are explicitly described within this document and several further advantages that a person skilled in the art can infer.

Although the present subject matter has been illustrated more specifically and explained in detail by example embodiments, the present subject matter is not restricted by the disclosed examples and other variations can be derived therefrom by a person skilled in the art without departing from the scope of protection of the present subject matter. It is therefore clear that a multiplicity of possibilities for variations exist.

It is likewise clear that embodiments mentioned by way of example represent examples which are not to be considered in any way as limiting for instance the range of protection, the possibilities for applications or the configuration of the present subject matter. Instead, the preceding description and the description of the figures enable a person skilled in the art to implement in practice the embodiments given by way of example, while the person skilled in the art, knowing the disclosed concept of the present subject matter, can carry out various changes, for example, with regard to the function or the arrangement of individual elements mentioned in an embodiment given by way of example, without departing from the scope of protection that is defined by the claims and their legal equivalents, such as for instance further explanations in the description.

1.-10. canceled.

11. A method for detecting usage data in a vehicle, comprising:
receiving configuration data, which are intended for a user interface of the vehicle, via a communication unit of the vehicle;
configuring the user interface based on the configuration data;
detecting usage data based on a usage of the user interface by a user of the vehicle; and
sending the usage data via the communication unit.

12. The method according to claim 11, comprising:
detecting response data based on a response of the user concerning the usage of the user interface by the user; and
sending the response data via the communication unit.

13. The method according to claim 11, comprising:
receiving second configuration data, which is intended for the user interface, via the communication unit, the second configuration data differing from the configuration data; and
configuring the user interface based on the second configuration data.

14. The method according to claim 11, comprising:
storing current configuration data of the user interface as second configuration data, the storing of the second configuration data taking place before the receiving of the configuration data; and
configuring the user interface based on the second configuration data.

15. The method according to claim 11, comprising:
modifying the configuration data based on the usage data and/or of the response data to obtain modified configuration data; and
configuring the user interface based on the modified configuration data.

16. The method according to claim 11, comprising:
transmitting a request for participation in a detection of usage data to a mobile terminal of the user; and
receiving a confirmation of the user's participation, wherein
the steps of transmitting the request and receiving the confirmation take place before the step of receiving the configuration data.

17. The method according to claim 11, comprising:
detecting an assessment of the usage of the user interface by the user, the assessment including one or more parameters that qualitatively and/or quantitatively characterize the usage of the user interface by the user.

18. A system for detecting usage data in a vehicle, comprising:
an electronic control unit to perform the method of claim 11;
the communication unit; and
the user interface.

19. The system according to claim 11, further comprising:
a backend component to:
send the configuration data to the vehicle via the communication unit; and
receive the response data from the vehicle.

20. A vehicle, comprising:
the system of claim 18.
